(19) United States
(12) Patent Application Publication
(10) Pub. No.: US 2007/0218859 A1
(43) Pub. Date: Sep. 20, 2007

(54) Method for switching operation modes of a mobile communication apparatus

(75) Inventor: Zhong-Yang Wang, Shanghai City (CN)

Correspondence Address: BIRCH STEWART KOLASCH & BIRCH, PO BOX 747, FALLS CHURCH, VA, 22040-0747, US

(73) Assignee: Inventec Appliances Corp.

(21) Appl. No.: 11/607,861

(22) Filed: Dec. 4, 2006

(30) Foreign Application Priority Data
Mar. 17, 2006 (TW) 95109306

(51) Int. Cl. H04B 1/16; H04B 1/38

(52) U.S. Cl. 455/343.1; 455/574

(57) ABSTRACT

A method for switching operation modes of a mobile communication apparatus, capable of switching automatically to a preferable operation mode in meeting an ambient change, includes the steps of: providing a mobile communication apparatus having a power-saving mode; detecting an ambient-brightness value of the surroundings of the mobile communication apparatus; comparing the ambient-brightness value with a preset value to obtain a comparison result; and turning on/off the power-saving mode in accordance with the comparison result.

### BACKGROUND OF THE INVENTION

(1) Field of the Invention

The invention relates to a method for switching operation modes of a mobile communication apparatus, and more particularly to the switching method that can alter the operation mode of the mobile communication apparatus by comparing with its surroundings for power saving.

(2) Description of the Prior Art

Recently, the mobile communication apparatus such as the mobile phone, the personal digital assistant (PDA), the smart phone and so on has been raised from a simple communication device to a versatile role having functions in wireless networking, personal assisting, information and entertainment providing and so on. Precisely, the mobile communication apparatus has become one of paramount devices in people's daily life.

Naturally, as functions of the mobile communication apparatus become more versatile, the power consumption thereof also becomes an issue that can't be overlooked. To ease the power consumption problem, various technique proposals in increasing the battery capacity, upgrading the power management efficiency and developing power-saving elements have been suggested.

Among various techniques in power management of the mobile communication devices, one of them is to save the electricity by terminating some of optional and unnecessary functions.

Actually, some functions of the mobile communication device are particularly provided to meet some special demands. These functions include backlight of the keypad, display time of the screen backlight, flash display, vibration mode and vibration time for incoming calls, and so on. By terminating or adjusting some of these optional functions in accordance with the user demands, the usage time for a full charge of the mobile communication device can be substantially prolonged.

However, to adjust or terminate the optional functions, the user needs to enter the setting interfaces of the device and to adjust the functions one-by-one. Sometimes, such an operation does bother the user and may make him/her feel inconvenient.

Another proposal is to integrate all the setting interfaces into a single setting interface. Further, the new setting values can be saved and grouped as an operation mode. As long as the mobile communication device is set on this operation mode, the functions of the device will be automatically started or terminated in accordance with the setting values stored in the operation mode.

That is to say that the user may, according to his/her personal need, store various groups of the parameters to different operation modes. Namely, among various operation modes, the setting values to control the same element of the mobile communication device may be varied. For example, the response of mobile communication device can have a conference mode, an outdoor mode, an indoor mode, a mute mode and so on.

Nevertheless, though such an application of the operation modes may help the user to set the device in a mode relevant to its surroundings, yet the application does not help in upgrading the power management of the device.

For example, in the case that a user chooses a power-saving mode to terminate majority backlight displays of the device, the mobile communication device is obviously not relevant to be used in the dark surroundings. For the device to be used in the dark surroundings, the user needs to terminate the power-saving mode so as to gain back the backlight displays.

Similarly, as soon as the user enters the bright surroundings, the power-saving mode of the mobile communication device shall be re-started so as to get back the advantage of power saving.

Apparently, the user needs to switch frequently around various operation modes of the mobile communication device so as to meet different ambient conditions and to save the electricity. Such an operation of the mobile communication device is obviously notorious and frustrates the user. Further, it is also painful to the user to ponder whether or not a switching of the operation modes is required to meet the present surroundings.

Therefore, how to enhance the comfort degree in switching around various operation modes of the mobile communication device without sacrificing the power-saving advantage is definitely one of crucial topics in developing the mobile communication devices.

### SUMMARY OF THE INVENTION

Accordingly, it is an object of the present invention to provide a method for switching operation modes of a mobile communication apparatus which can switch automatically to a preferable operation mode in meeting an ambient change.

The switching method of the present invention comprises the following steps.

Firstly, a mobile communication apparatus is provided to have a power-saving mode.

Secondly, an ambient-brightness value of the surroundings of the mobile communication apparatus is detected.

Thirdly, the ambient-brightness value is compared with a preset value to obtain a comparison result.

Finally, the power-saving mode is turned on/off in accordance with the comparison result.

In addition, the mobile communication apparatus having an automatic-switching mode in accordance with the present invention comprises a storing module and a photo detector.

The storing module is used for storing a power-saving mode and a preset ambient-brightness value.

The photo detector is used for detecting an ambient-brightness value of the surroundings of the mobile communication apparatus.

Wherein the mobile communication apparatus turns on/off the power-saving mode so as to save electricity by judging a comparison result between the ambient-brightness value and the preset ambient-brightness value.

All these objects are achieved by the method for switching operation modes of a mobile communication apparatus described below.

### BRIEF DESCRIPTION OF THE DRAWINGS

The present invention will now be specified with reference to its preferred embodiment illustrated in the drawings, in which:

FIG. 1 is a flowchart of a preferred method for switching operation modes of a mobile communication apparatus in accordance with the present invention.

### DESCRIPTION OF THE PREFERRED EMBODIMENT

The invention disclosed herein is directed to a method for switching operation modes of a mobile communication apparatus. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

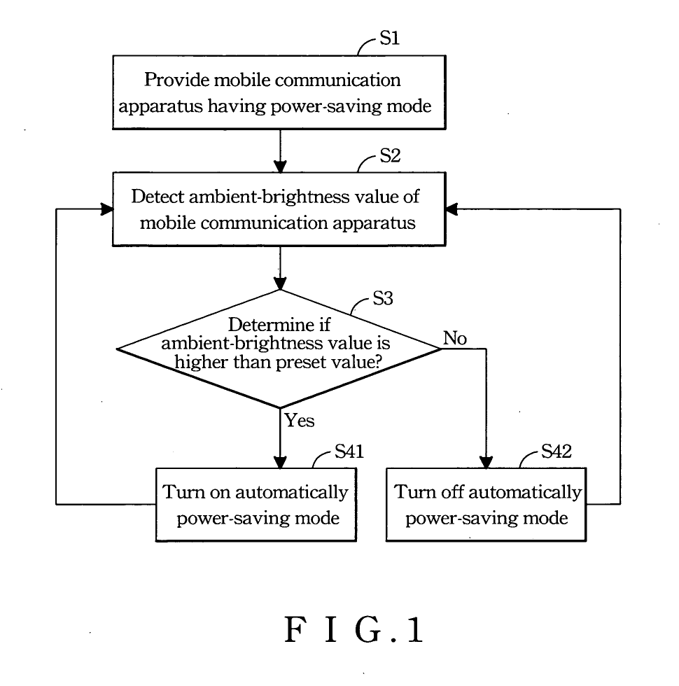

Referring now to FIG. 1, a flowchart of a preferred method for switching operation modes of a mobile communication apparatus in accordance with the present invention is shown. The switching method comprises the steps as follows.

S1: Provide a mobile communication apparatus having a power-saving mode. The power-saving mode stores a plurality of preset ambient-brightness values. These preset ambient-brightness values can be set by the manufacturer or by the user per his/her needs.

Generally, the mobile communication apparatus may include other operation modes. Every operation mode stores its own preset values for determining on/off of or adjusting elements of the mobile communication apparatus.

S2: Detect an ambient-brightness value of the surroundings of the mobile communication apparatus. In this step, the detection is repeatedly carried out by a constant sampling base. The constant sampling base is defined by a time interval which can be determined and varied by the power consumption rates and the frequencies of the surrounding change of the mobile communication apparatus.

Preferably, a photo detector for detecting the ambient-brightness value can be included in the mobile communication apparatus. Also, the mobile communication apparatus can also have a digital camera module and an automatic exposure module. The photo detector can be included to the automatic exposure module. By judging the ambient-brightness value, an aperture value and a shutter value, or even a flash exposure value, for the digital camera module can be decided, and thereby the light intensity into the digital camera module can be controlled.

In the Step S2, the photo detector of the automatic exposure module or an isolated photo detector can be directly used for detecting the ambient-brightness value of the surroundings of the mobile communication apparatus.

S3: Comparing the detected ambient-brightness value with a preset value to determine whether or not the ambient-brightness value is higher than the preset value. The preset value, or say the preset ambient-brightness value, can be a value preset by the manufacturer, or a value that is set by the user. Preferably, the comparison in this step can be performed by a processing chip of the mobile communication apparatus.

S4: Turn on/off the power-saving mode in accordance with a comparison result from comparing the detected ambient-brightness value with the preset value (i.e. from Step S3). Namely, the step S4 is performed right after the processing chip judges the comparison result. In the present invention, the step S4 can be further divided into step S41 and step S42.

In the case that the comparison result is positive (i.e. the ambient-brightness value is higher than the preset value), the backlight displays of the mobile communication apparatus can be reduced for the surroundings can provide sufficient illumination. Then, the step S41 is performed to initiate the power-saving mode.

When the power-saving mode is turned on, the values stored in this mode are used to adjust the state of the mobile communication apparatus, for example, by turning off backlight of the screen, turning off backlight of the keypad, turning off the flash display for incoming calls, and so on. Thereby, the power consumption of the mobile communication apparatus can be substantially lowered.

After the power-saving mode is turned on, the method proceeds to perform the step S2 so as to constantly detect the ambient change. Upon such an arrangement, the power-saving mode can always come into action automatically in the right time.

In the case that the comparison result is negative (i.e. the ambient-brightness value is lower than the preset value), the backlight displays of the mobile communication apparatus can be enhanced for the surroundings is too dark to provide sufficient illumination. Then, the step S42 is performed to turn off automatically the power-saving mode.

After the power-saving mode is turned off, the setting values of the mobile communication apparatus can be resumed to those values before the power-saving mode is turned on.

In the present invention, the mobile communication apparatus can also include a high-illumination mode which provides more backlight (i.e. brightness) to display selective elements of the apparatus. After the aforesaid power-saving mode is turned off, the high-illumination mode can be introduced, if necessary.

Surely in the present invention, the operation mode to be turned on after terminating the power-saving mode can also be defined by the user.

In the present invention, no matter what the operation mode is on, the step S2 is never stopped to detect the ambient brightness, so that a proper operation mode suitable to the current surroundings can always be performed.

In the present invention, the preferred mobile communication apparatus having an automatic-switching mode in accordance with the present invention comprises:

A storing module for storing the power-saving mode and the preset ambient-brightness value; and

A photo detector for detecting the ambient-brightness value of the mobile communication apparatus.

The mobile communication apparatus turns on/off the power-saving mode so as to save electricity by judging a comparison result from comparing the ambient-brightness value with the preset ambient-brightness value.

By providing the aforesaid method and apparatus of the present invention, a preferable operation mode can be anytime automatically chosen to the mobile communication apparatus by sampling the ambient brightness. Upon such an arrangement, the operation mode of the mobile communication apparatus can always be the one that meets the surrounding requirement and the one that saves the electricity without constantly bothering the user.

While the present invention has been particularly shown and described with reference to a preferred embodiment, it will be understood by those skilled in the art that various changes in form and detail may be without departing from the spirit and scope of the present invention.

I claim:

1. A method for switching operation modes of a mobile communication apparatus, comprising the steps of:
providing a mobile communication apparatus having a power-saving mode;
detecting an ambient-brightness value of the mobile communication apparatus;
comparing the ambient-brightness value with a preset value to obtain a comparison result; and
turning on/off the power-saving mode in accordance with the comparison result.

2. The method for switching operation modes of a mobile communication apparatus according to claim 1, wherein said power-saving mode is turned on when said ambient-brightness value is higher than said preset value.

3. The method for switching operation modes of a mobile communication apparatus according to claim 1, wherein said power-saving mode is turned off when said ambient-brightness value is lower than said preset value.

4. The method for switching operation modes of a mobile communication apparatus according to claim 3, wherein said mobile communication apparatus further includes a high-illumination mode that is turned on after said power-saving mode is turned off.

5. The method for switching operation modes of a mobile communication apparatus according to claim 1, wherein said power-saving mode stores at least a setting value, said mobile communication apparatus being adjusted in accordance with the setting value as said power-saving mode is turned on.

6. The method for switching operation modes of a mobile communication apparatus according to claim 5, wherein said setting value is determined by a user.

7. The method for switching operation modes of a mobile communication apparatus according to claim 1, wherein said “detecting an ambient-brightness value of the mobile communication apparatus” is to carry out the detecting repeatedly by a constant sampling base defined by a time interval.

8. The method for switching operation modes of a mobile communication apparatus according to claim 1, wherein said mobile communication apparatus further includes a photo detector for detecting said ambient-brightness value.

9. The method for switching operation modes of a mobile communication apparatus according to claim 1, wherein said mobile communication apparatus further includes a digital camera module and an automatic exposure module, the automatic exposure module further including a photo detector for detecting said ambient-brightness value.

10. The method for switching operation modes of a mobile communication apparatus according to claim 1, wherein said mobile communication apparatus is selected from the group of a mobile phone, a PDA and a smart phone.

11. The method for switching operation modes of a mobile communication apparatus according to claim 10, wherein said mobile communication apparatus is said mobile phone.

12. A mobile communication apparatus having an automatic-switching mode, comprises:
a storing module for storing a power-saving mode and a preset value; and
a photo detector for detecting an ambient-brightness value of the mobile communication apparatus;
wherein the mobile communication apparatus turns on/off the power-saving mode in accordance with a comparison result by comparing the ambient-brightness value with the preset value.

13. The mobile communication apparatus having an automatic-switching mode according to claim 12, wherein said power-saving mode is turned on when said ambient-brightness value is higher than said preset value.

14. The mobile communication apparatus having an automatic-switching mode according to claim 12, wherein said power-saving mode is turned off when said ambient-brightness value is lower than said preset value.

15. The mobile communication apparatus having an automatic-switching mode according to claim 14, wherein said storing module further has a high-illumination mode that is turned on after said power-saving mode is turned off.

16. The mobile communication apparatus having an automatic-switching mode according to claim 12, wherein said power-saving mode stores at least a setting value, said mobile communication apparatus being adjusted in accordance with the setting value as said power-saving mode is turned on.

17. The mobile communication apparatus having an automatic-switching mode according to claim 15, wherein said setting value is determined by a user.

18. The mobile communication apparatus having an automatic-switching mode according to claim 12, wherein said mobile communication apparatus is to detect said ambient-brightness value repeatedly by a constant sampling base defined by a time interval.

19. The mobile communication apparatus having an automatic-switching mode according to claim 12, wherein said mobile communication apparatus further includes a digital camera module and an automatic exposure module, wherein said photo detector is included to the automatic exposure module.

20. The mobile communication apparatus having an automatic-switching mode according to claim 12, wherein said mobile communication apparatus is a mobile phone.
